(19) United States
(12) Patent Application Publication
(10) Pub. No.: US 2014/0226955 A1
(43) Pub. Date: Aug. 14, 2014

(54) GENERATING A SEQUENCE OF VIDEO CLIPS BASED ON META DATA

(71) Applicant: TAKES LLC, Wilmington, DE (US)

(72) Inventor: Amit MAN, Tel Aviv (IL)

(73) Assignee: Takes LLC, Wilmington, DE (US)

(21) Appl. No.: 13/764,986

(22) Filed: Feb. 12, 2013

(51) Int. Cl. H04N 9/79

(52) U.S. Cl. CPC H04N 9/79
USPC 386/285; 386/290

(57) ABSTRACT

A method of generating a sequence of video clips based on metadata is provided herein. The method includes receiving a plurality of multimedia files, wherein each one of the multimedia files is associated with kinematic data related to a capturing of each one of the multimedia files, and a key moment being a time stamp indicated by a user; obtaining a displaying order of the multimedia files; applying a decision function, wherein the decision function receives as an input the plurality of multimedia files, the respective key moments, the displaying order, and the kinematic data and determines as an output, for each one of the multimedia files, a start point and an end point, wherein the start point and end point of each one of the multimedia files are determined, at least partially, on relations between snap shot moments and kinematic data of the plurality of multimedia files.

### FIELD OF THE INVENTION

The present invention relates to the field of video and image processing, and more particularly, to video clips generating and editing.

### BACKGROUND OF THE INVENTION

Video clip generation is currently known to involve software platform which enable users to join together a plurality of video sequences (and their corresponding audios) to form a sequence of these clips that can be played back as a single video. Video editing is also well known in the art and there are many products that enable a user to edit multimedia files by stitching together different multimedia clips.

These platforms usually allow the user to first select the video clips that will participate in the video sequence and then determine the order of the video clips in the video sequence. Finally, some form of video editing is provided, such as changing the length of each one of the video clips, enhancing the video quality and the like.

A more basic form of video-like product is generated by a software platform that generates an animated presentation of still images. The animated presentation may be in the form of a still images sequence shown in a specified order in a manner that provides some sort of motion. For example, when several still images are taken short period of time apart from each other and are shown one by one some form of an animated sequence is achieved.

### BRIEF SUMMARY

According to one aspect of the present invention there is provided a method of generating a displayable video (or multimedia) based on metadata. The method may include the following stages: receiving a plurality of multimedia files, wherein each one of the multimedia files is associated with kinematic data related to a capturing of each one of the multimedia files, and a key moment being a time stamp indicated by a human user; obtaining a displaying order of the multimedia files; applying a decision function, wherein the decision function receives as an input the plurality of multimedia files, and at least one of the following: the respective snap shot moments, the displaying order, and the kinematic data and determines as an output, for each one of the multimedia files, a start point and an end point, wherein the start point and end point of each one of the multimedia files are determined, at least partially, based on relations between snap shot moments and potentially but not necessarily, the kinematic data attributed to the capturing process of the plurality of multimedia files.

### BRIEF DESCRIPTION OF THE DRAWINGS

The subject matter regarded as the invention is particularly pointed out and distinctly claimed in the concluding portion of the specification. The invention, however, both as to organization and method of operation, together with objects, features, and advantages thereof, may best be understood by reference to the following detailed description when read with the accompanying drawings in which:

FIG. 1 is a schematic illustration of a system for making a making a sequence of multimedia clips based on a still image capturing process according to embodiments of the present invention;

FIG. 2 is a high level flowchart illustrating the steps of a method for making a sequence of multimedia clips based on a still image capturing process according to embodiments of the present invention;

FIG. 3 is a schematic illustration of a system for making a video based on a still image capturing process according to embodiments of the present invention;

FIG. 4 is a schematic illustration of an exemplary timeline of image data captured by a camera according to embodiments of the present invention;

FIG. 5 is a schematic illustration of a selection, according to embodiments of the present invention, of a portion of image data captured during a capturing process period;

FIG. 6 is a schematic illustration of an exemplary timeline of image data captured by a camera and an exemplary timeline of a movie created according to embodiments of the present invention; and

FIG. 7 is a schematic illustration of a method for creating a video according to embodiments of the present invention.

It will be appreciated that for simplicity and clarity of illustration, elements shown in the figures have not necessarily been drawn to scale. For example, the dimensions of some of the elements may be exaggerated relative to other elements for clarity. Further, where considered appropriate, reference numerals may be repeated among the figures to indicate corresponding or analogous elements.

### DETAILED DESCRIPTION OF THE PRESENT INVENTION

In the following detailed description, numerous specific details are set forth in order to provide a thorough understanding of the invention. However, it will be understood by those skilled in the art that the present invention may be practiced without these specific details. In other instances, well-known methods, procedures, and components have not been described in detail so as not to obscure the present invention.

Embodiments of the present invention may enable a user to create video clips by using still images captured in an unusual manner. While it is possible according to embodiments of the present invention to create video stories, the captured still images may be stored and may still be watched as regular still images. The experience of generating of sequence of video clips may resemble ordering regular albums of still images while the outcome would be an intelligently edited sequence of clips. Thus, embodiments of the present invention may enable creation of videos in a very quick and/or convenient manner.

Since the videos made according to embodiments of the present invention may be made of a plurality of selectively taken images, the video may look active and interesting. Additionally, every shot of the video may be meaningful and intentional. Additionally, the video content may include shots that span over time and/or location.

The present invention, in embodiments thereof, provides a method for generating a displayable sequence of multimedia clips from a set of captured media files, characterized in that the capturing of each one of the media files was carried out merely based on a single still—like capturing operation (i.e., a ‘click’) and various inputs related to the context of the capturing moment. The output of embodiments of the present invention is a multimedia sequence which accumulates at least two sequences—one of video clips and the other of audio clips, all taken implicitly by a user who has captured both video media files and audio media files, merely by determining a plurality of capturing moments that were late mapped into respective audio and video clips.

It will be appreciated that throughout the present document, an image capturing process is the process of capturing a still image, for example by aiming a camera, for example at an object and/or view to be captured, and clicking a real button or a virtual touch screen button, for example, of a smartphone camera. Therefore, according to embodiments of the present invention, a combined video may be created by joining short videos created based on data recorded during the image capturing processes.

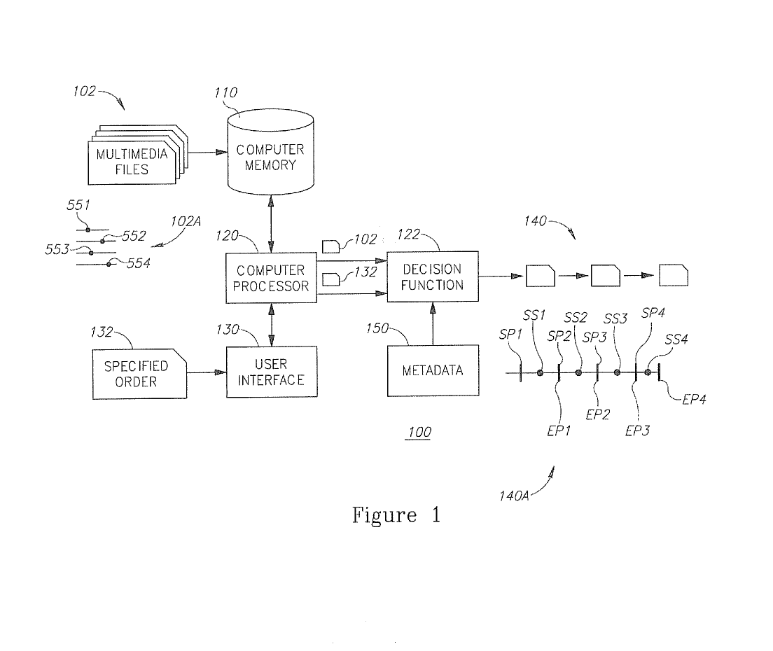

FIG. 1 is a schematic illustration of a system 100 for generating a sequence of multimedia clips based on a pre-captured multimedia files 102, according to embodiments of the present invention. System 100 includes a computer memory 110 configured to receive and store a plurality of multimedia files 102, wherein each one of the multimedia files 102 is associated with kinematic data related to a capturing process of each one of the multimedia files 102, and a key moment being a time stamp indicated by a user. As can be seen, each one of multimedia files 102A received as an input to system 100 has a time stamp 551-554 indicting a moment along the time axis in which the user has pressed/touched a capturing button, i.e. key moments.

System 100 further includes a user interface 130 configured to enable a user to provide a displaying order 132 of the multimedia files. User interface 130 may be for example executed by, or may be part of, processor 120 described herein. Preferably, the user may provide an order of still images, each associated with a key moment, so that instead of ordering multimedia files, the user orders a set of still images.

System 100 further includes a computer processor 120. Processor 120 may execute software or instructions (e.g. stored in memory 110) to carry out methods as disclosed herein.

Processor 120 is configured to apply a decision function 122, wherein the decision function 122 receives as an input the plurality of multimedia files 102, and at least one of the following: the respective key moments, the displaying order 132, and the kinematic data and determines as an output 140A, for each one of the multimedia files, a start point (such as SP1, SP2, SP3, and SP4) and an end point (such as EP1, EP2, EP3, and EP4). The start point and end point of each one of the multimedia files are determined, at least partially, based on relations between key moments and kinematic data of the plurality of the multimedia files.

According to some embodiments, computer processor 120 is further configured to generate a displayable sequence of multimedia clips 140 such as, for example, output 140A, each multimedia clip being a subset of its respective multimedia file 102, starting at its respective start point (such as SP1, SP2, SP3, and SP4) and ending at its respective end point (such as EP1, EP2, EP3, and EP4) by stitching together the multimedia clips based on the specified display order.

According to some embodiments, each one of the multimedia file comprises a video sequence and wherein the key moment is associated with a single still image.

According to some embodiments, the determining of the start points and end points by the decision function is further based on data derived from the respective single still image.

According to some embodiments, computer processor 120 is further configured to tag each one of the multimedia clips with tags indicative of data derived from the still image. Additionally, computer processor 120 is further configured to apply a predefined operation to the sequence of multimedia clips, based on the tags. Alternatively, some of the tagging-related processes such as analysis and data processing may be carried out on a server remotely connected to system 100.

More specifically, computer processor 120 is further configured to apply a search operation for or on the sequence of the multimedia clips, based on the tags. Searching within the sequence may be focused at specific clips wherein searching the sequence relates to finding the sequence in its entirety within a larger multimedia file.

According to some embodiments, at least some of the multimedia files may include both a video sequence and an audio sequence and wherein the decision function may determine different start points and end points for at least some of the multimedia files. For example, for at least some of the multimedia files, the audio sequence may have a different start or end point from the video sequence.

According to some embodiments, computer processor 120 may be further configured to receive metadata 150 associated with the plurality of the multimedia files, metadata 150 may be provided as input to the decision function, and wherein the decision function may determine the start points and end points of the multimedia clips further based on the metadata 150. More specifically, computer processor 120 may be further configured to receive a one or more audio files that will be used as a soundtrack for the generated sequence of multimedia clips, and wherein the decision function determines the start points and end points of the multimedia clips further based on a tempo derivable from the soundtrack or the length of the soundtrack.

According to some embodiments, at least some additional multimedia files may be provided after the originally provided additional multimedia files, e.g. after start and end points are determined by the decision function based on the originally provided additional multimedia files, and wherein the additional multimedia files associated with specified display times along the specified order so that the decision function is re-applied to determine updated start points and end points of both originally provided multimedia files and the additional multimedia files. It should be understood that the addition of multimedia files brings along the kinematic data and other metadata as well as respective key moments of these additional multimedia files and the entire order as well as the start and end points of each one of the multimedia clips is being revised and updated. This feature may allow a user to edit, in a later time, the originally produces sequence of clips (produced by either same user or another user) by interleaving his or her clips into the originally created sequence of multimedia clips.

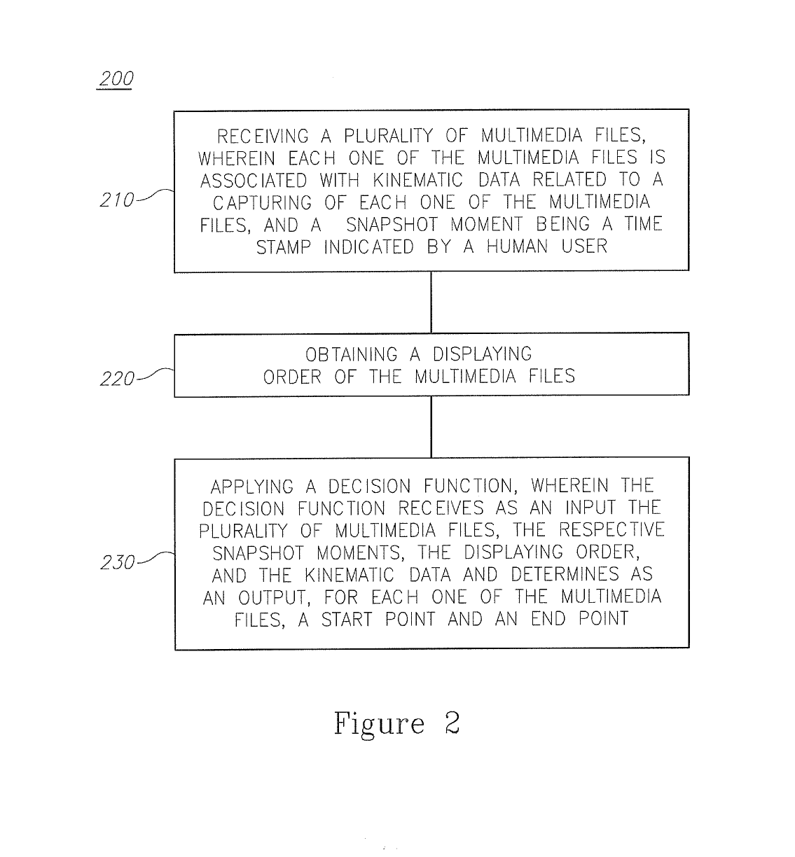

FIG. 2 is a high level flowchart illustrating the steps of a method 200 for generating a sequence of video clips based on metadata. Method 200 starts off with the step of receiving a plurality of multimedia files, wherein each one of the multimedia files is associated with at least one of the following: kinematic data related to a capturing of each one of the multimedia files, and a key moment being a time stamp indicated by a human user 210. The method goes on to the step of obtaining a displaying order of the multimedia files 220. Then, method 200 proceeds to a step of applying a decision function, wherein the decision function receives as an input the plurality of multimedia files, and at least one of the following: the respective snap shot moments, the displaying order, and the kinematic data and determines as an output, for each one of the multimedia files, a start point and an end point 230. Specifically, the decision function is applied so that the start point and end point of each one of the multimedia files are determined, at least partially, based on relations between key moments and kinematic data of the plurality of the multimedia files.

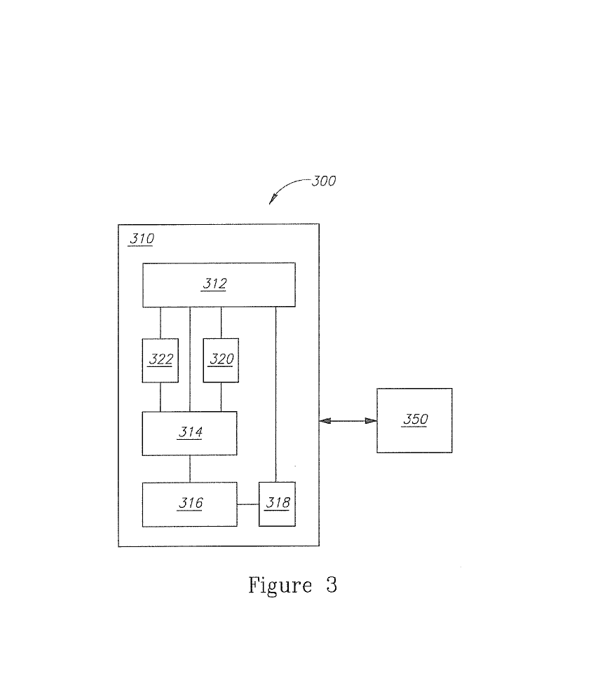

For the sake of completeness, FIG. 3 illustrates a system 300 that may provide the input to aforementioned system 100 according to embodiments of the present invention. It should be noted here that any reference herein to video may include also audio and the process of video sequence generation includes the audio sequence generation that accompanies it. System 300 may include a device 310 that may constitute, for example, a mobile phone, a smartphone, a camera phone, a tablet computer or any other suitable device. Device 310 may include a processor 312 (which may be the same as or similar and/or function similarly to processor 120), a memory 314, a camera 316 and a user interface 318. User interface 318 may be for example executed by, or may be part of, processor 312. Additionally, device 310 may include an audio recorder 320 and an acceleration sensor 322 such as, for example, a three-axis gyroscope and/or an accelerometer. Additionally, system 300 may include an application server 350, which may be in interne communication with device 10, for example over wireless and/or cellular connections.

Device 310 may receive from application server 350 software items such as, for example, code and/or objects that may enable the making of a movie based on a still image capturing process according to embodiments of the present invention. For example, such software items may be downloaded and stored in memory 314 automatically or following a user command entered by user interface 318. For example, such software items may be downloaded and stored in memory 314 before and/or during the process of making a video based on a still image capturing data according to embodiments of the present invention. Memory 314 may include an article such as a computer or processor readable non-transitory storage medium, such as for example a memory card, a disk drive, or a USB flash memory encoding, including or storing instructions, e.g., computer-executable instructions, such as, for example, the software items downloaded from application server 350. When executed by a processor or controller such as processor 312, the instructions stored and/or included in memory 314 may cause the processor or controller to carry out methods disclosed herein.

In certain embodiments of the present invention, some of the processing required according to embodiments of the present invention may be executed in application server 350. For example, during execution of methods according to embodiments of the present invention, application server 350 may receive data, information, request and/or command from device 310, process the data, and send the processed data and/or any requested data back to device 310.

Camera 316 may include a light sensor of any suitable kind and an optical system, which may include, for example, one or more lenses. User interface 318 may include software and/or hardware instruments that may enable a user to enter commands into device 310, control device 310, receive and/or view data from device 310, etc, such as, for example, a screen, a touch screen, a keyboard, buttons, audio input, audio recording software and hardware, voice recognition software and hardware, vocal/visual indications by device 310 and/or any other suitable user interface software and/or hardware.

By user interface 318 a user may, for example, take pictures by camera 316 and/or control camera 316. Pictures taken by camera 316, along with accompanying data, may be stored at memory 314. According to embodiments of the present invention, taking a picture by camera 316 may involve production of a data file (e.g., a video and/or an audio file) associated with each one of the taken pictures. For example, the data file according to embodiments of the present invention may include the image data of the taken picture along with additional data such as, for example, video or audio data recorded during, before and/or after the actual capturing moment of the picture. The data included in the data file may be recorded during a time period starting before the capturing moment and ending after the capturing moment, which may be regarded as the capturing process period of time. For example, the capturing process period may start once camera 16 is initiated and ready to take a picture. The capturing process period may end, for example, once the camera is ready to take another picture, e.g. a few seconds or less after a picture is taken, or, for example, once the camera stops running, such as, for example, when it is logged out or turned off, or the screen of device 310 is shut down. Accordingly, the data file may include, for example, image data captured during, before and/or after the actual capturing moment. Additionally, the data file may include audio data recorded, for example, by an audio recorder 320 included in device 310 during, before and/or after the actual capturing moment. Additionally, the image data may include information about location, position, acceleration magnitude and/or direction, velocity and/or any other three-dimensional motion magnitude of the device during, before and after the actual capturing moment, that may be gathered, for example, by an acceleration sensor 322 included in device 310. It is therefore an aspect of the present invention to determine, for each capturing moment, a start point and an end point of the corresponding video or audio clip.

The capturing moment may be the moment when a picture is taken following a user command. Usually, the capturing moment occurs a short while after a user touches or pushes the camera button in order to take a picture, usually but not necessarily after a certain shutter lag period that may be typical for the device and/or may depend on the environmental conditions such as, for example, lighting of the imaged environment, movement and/or instability of the device, etc.

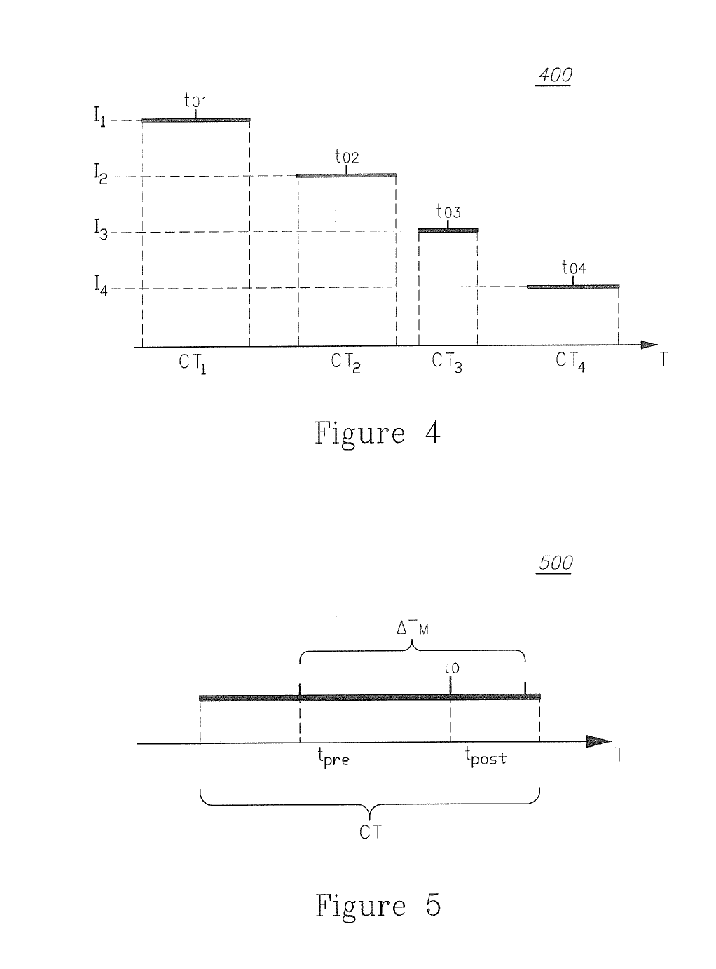

Reference is now made to FIG. 4, which is a schematic illustration of an exemplary timeline 400 of image data captured by a camera according to embodiments of the present invention, for example by camera 316. For the sake of simplicity, the audio files are omitted here but it is understood that a similar mechanism for generating video files may be provided for audio files so that an ordered set of audio files, each with its own start point and end point determined based on the key moment and various other context related data may be also provided.

By way of example, and without limitation, relating to video clips only, a user may capture several images I₁, I₂, I₃ and I₄ and so forth along time, shown in FIG. 4 by an axis T. Although FIG. 4 refers to four images I₁, I₂, I₃ and I₄, the invention is not limited in that respect and any other number of images can be used according to embodiments of the present invention. According to embodiments of the present invention, as discussed above, each taken picture I₁, I₂, I₃ and I₄ and so on may be stored as image data along with data recorded during, before and/or after the actual capturing moments t₀₁, t₀₂, t₀₃, and t₀₄ of the pictures, respectively. As discussed above, processor 312 may record capturing process data, which may include data recorded during a capturing process period, including image data recorded before, during and after a capturing moment of a picture. As discussed above, the capturing process data may additionally include data about location, orientation, acceleration, velocity of the device and/or any other suitable data that may be recorded during the capturing process period such as. Accordingly, the data included in the data file, e.g. multimedia file, may be recorded during a time period starting before the capturing moment and ending after the capturing moment, which may be regarded as the capturing process period of time, shown in FIG. 4 2 as CT₁, CT₂, CT₃ or CT₄, respectively. As discussed above, the capturing process period CT₁, CT₂, CT₃ or CT₄ may start once camera 316 is initiated and ready to take a picture. The capturing process period CT₁, CT₂, CT₃ or CT₄ may end, for example, once the camera is ready to take another picture, e.g. a few seconds or less after a picture is taken, or, for example, once the camera stops running, such as, for example, when it is logged out or turned off, or the screen of device 310 is shut down. Accordingly, the data file may include, for example, the captured image data file, a video data file and a capturing process metadata file 150. The captured image data file may include the image data of the captured image. The video data file may include image data captured during, before and/or after the actual capturing moment t₀₁, t₀₂, t₀₃, or t₀₄, that the video clips—as the audio and video clips may not be entirely overlapping—for example by an audio recorder included in device 310. The capturing process metadata file 150 may include capturing process data such as, for example, information about location, position, orientation, acceleration (spatial and/or angular) and/or velocity (spatial and/or angular) of the device during, before and after the actual capturing moment, e.g. during the capturing process period.

For the sake of completeness, in order to further explain the nature of the input to system 100, reference is now made to FIG. 5, illustrating a selection, shown as a time line 500, of a portion DT_{M} of image data captured during a capturing process period CT. Again, for the sake of simplicity, audio files are not shown here and are basically treated similarly to video clips—each audio file is stored separately as the generation of the video sequence involves both video clips and audio clips joined together wherein a complete overlap between video clips and audio clips captured together is not necessary—and each may have a different length.

Axis T in FIG. 5 represents time. Processor 312 may select a portion DT_{M} of the image data recorded during the capturing process period CT, which may be included in the stored data file related to an original picture captured at capturing moment t₀. Portion DT_{M} may include the capturing moment t₀ itself, a period of time tₚᵣₑ, which is a period of time before the capturing moment t₀ and/or a period of time tₚₒₛₜ, which is a period of time after the capturing moment t₀.

As mentioned above, the selection of portion DT_{M} may be based on predetermined data and/or criteria that may be determined in order to identify a portion of the image data that may be consistent with the user's intentions when capturing the image. For example, processor 312 may identify, based on predetermined criteria, a portion of the image data that may be relatively consistent and continuous with respect to the original captured picture. Processor 312 may analyze predetermined data of the capturing process data. In some embodiments of the present invention, processor 312 may analyze the device movement during the capturing process period, for example, based on metadata such as data about three-dimensional motion, location, orientation, acceleration magnitude and/or direction, velocity of the device that was recorded during the capturing process period and included in a metadata file 150. Processor 312 may analyze the metadata and recognize, for example, a portion of the capturing process period when the movement is relatively smooth and/or monotonic, e.g. without sudden changes in velocity and/or orientation and or with small magnitude of acceleration, for example according to a predetermined threshold of amount of change in velocity and/or orientation. Additionally, processor 312 may identify a path of the device in space. The path of the device in space may be relative to predefined constrains such as ‘a path entirely above waist level of the user’.

The path may be retrieved, for example, based on data about location and orientation of the device that was recorded during the capturing process period and included in the metadata file. Processor 312 may analyze the recorded and identified path and determine, for example, a portion of the capturing process period in which the path is relatively continuous and/or fluent. Relative fluency and/or continuousness may be recognized according to a predetermined threshold of change amount, for example, in direction and/or location. Additionally, processor 312 may analyze the image data recorded on, before and/or after the capturing moment and recognize transition moments in the image data, such as relative sudden changes in the imaged scene. Relative sudden changes in the imaged scene may be recognized, for example, according to a predetermined threshold of change amount in the video data clip.

Based on the analyses of the recorded data, processor 312 may select a portion of the recorded image data, for example based on predetermined criteria. For example, it may be predetermined that the selected portion should include the original captured picture. For example, it may be predetermined that the selected portion should not include relative sudden changes in the imaged scene. For example, it may be predetermined that the selected portion should include a relatively fluent and/or continuous path of the device in space. For example, it may be predetermined that the selected portion should not include sudden changes in velocity and/or orientation. Other suitable analyses and criteria may be included in the method in order to select the image data portion that may mostly suit the user's intention when taking the picture. The selected portion may constitute a video segment that may be associated with the original taken picture. Accordingly, a plurality of video segments selected according to embodiments of the present invention may each be stored, for example in memory 314, with association to image data of the respective original captured image. It should be noted that the aforementioned analysis and generation can preferably be carried out off-line, after the capturing sessions are over and when there is plenty of time and metadata to reach optimal generation of video clips and audio clips based on the capturing moments.

Alternatively, in some embodiments of the present invention, the analysis of the data and the selection of the image data portion may be performed in real time, e.g. during the capturing process. For example, during the capturing process, processor 312 may recognize relative sudden changes in velocity and/or orientation, and may select the portion when the movement is relatively smooth and/or monotonic. Additionally, during the capturing process, processor 312 may recognize transition moments in the image data, such as relative sudden changes in the imaged scene.

Additionally, for the sake of further explaining the nature of the input of system 100, processor 312 of the capturing process may learn the picture capturing habits of a certain user, for example a user that uses device 310 most frequently. For example, in some cases, a user may usually take pictures with a very short tₚᵣₑ before the picture is taken, or may have more or less stable hands and/or any other suitable shooting habits that may affect the criteria and/or thresholds used in selection of the most suitable portion of the image data. Based on the user's habits, processor 312 may regenerate criteria and/or thresholds according to which a most suitable portion of the image data may be selected.

In some embodiments, processor 312 may select along with a portion of the video data, a suitable portion of audio data recorded by device 10. The selection may be performed according to predetermined criteria. For example, it may be predetermined that the selected portion of recorded audio data includes audio data that was recorded at the capturing moment or proximate to the capturing moment. Additionally, for example, it may be predetermined that the selected portion of recorded audio data does not include a cutting off of a speaking person. For example, joining together two video clips is carried out so that in some cases the audio file of the first video file continues well into the second video clip, e.g, when the first audio data includes a continuous tone and/or volume characterizing speech. The selected audio segment may be joined with the selected video segment to create a movie that may be associated with the original captured picture.

In some embodiments, the selected video segments, possibly along with the selected audio segments, may be joined sequentially to create a joined video. In such cases, a video segment may continue along more than one video segment, and/or, for example, begin within one video segment and end within another video segment of the joined video segments.

According to embodiments of the present invention a user may select, for example by user interface 318, a plurality of captured images that he wishes to transform to a combined video. Additionally, the user may select the order in which the selected images should appear in the video.

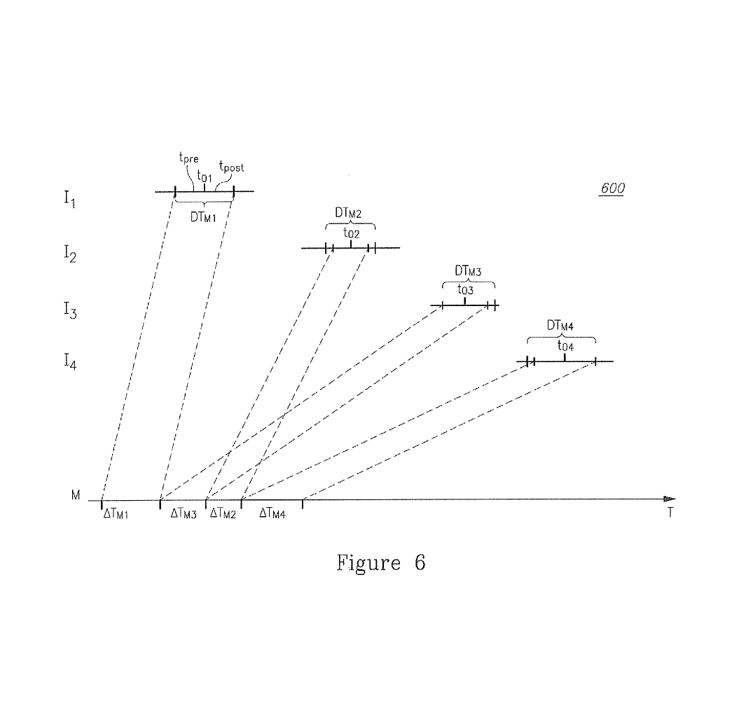

As discussed below with reference to FIG. 6, processor 312 may obtain a plurality of video and audio segments, with association to the respective original captured images as well as a variety of contextual metadata, from memory 314 or from application server 350 or from any other storage. The obtained video segments associated with respective original captured images may include, in some embodiments, image data recorded during the capturing process period, for example as discussed above with reference to FIG. 4, and/or selected portions of the image data, for example as discussed in detail with reference to FIG. 5. Processor 312 may receive the selection of images and/or selection of order of images from a user, in order to create a movie based on the selected images and/or order.

Reference is now made to FIG. 6, which is a schematic illustration of an exemplary timeline of image data captured by a camera and an exemplary timeline of a movie M created according to embodiments of the present invention For the sake of clarity, only imagery data is shown but it is understood that auditory data may also be used and the length of the imagery data and the auditory data may vary and not be identical, and audio segment may linger after one video clip ends and another video clips starts. Axis T1 in FIG. 6 represents time. For example, a user may capture several images I₁, I₂, I₃ and I₄ and so forth along time, shown by an axis T. Although FIG. 6 refers to four images I₁, I₂, I₃ and I₄, the invention is not limited in that respect and any other number of images can be used according to embodiments of the present invention. According to embodiments of the present invention, as discussed above, each taken picture I₁, I₂, I₃ and I₄ and so on may be stored as image data along with data recorded during, before and/or after the actual key moments t₀₁, t₀₂, t₀₃, and t₀₄ of the pictures, respectively. As discussed above, processor 312 may record capturing process data, which may include data recorded during a capturing process period, including image data recorded before, during and after a capturing moment of a picture. Accordingly, the data included in the data file may be recorded during a time period starting before the capturing moment and ending after the capturing moment, which may be regarded as the capturing process period of time. Accordingly, the data file may include, for example, image data captured during, before and/or after the actual capturing moment t₀₁, t₀₂, t₀₃, or t₀₄. processor 12 may obtain video segments, e.g. the captured image data segments DT_{M1}, DT_{M2}, DT_{M3} and DT_{M4}, with association to the respective original captured image I₁, I₂, I₃ and I₄, from memory 314 or from application server 50 or from any other storage. The obtained video segments associated with respective original captured images may include, in some embodiments, image data recorded during the capturing process period, for example as discussed above with reference to FIG. 4, and/or selected portions of the image data, for example as discussed in detail with reference to FIG. 5. Processor 312 may receive the selection of images and/or selection of order of images from a user, in order to create a movie based on the selected images and/or order.

For example, as shown in FIG. 6, processor 312 may create a movie by joining the image data or multimedia segments DT_{M1}, DT_{M2}, DT_{M3} and DT_{M4} in a selected order, for example DT_{M1} first, DT_{M3} second, DT_{M2} third and DT_{M4} forth, as shown in the example of FIG. 6. The selected order may be received and/or obtained, for example, by a user. Processor 312 may create the movie by joining DT_{M1} first, DT_{M3} second, DT_{M2} third and DT_{M4} forth in a smooth sequence, e.g. with seamless stitching. In order to create a smooth sequence, processor 312 may analyze the contents of the originally obtained image data or multimedia segments DT_{M1}, DT_{M2}, DT_{M3} and DT_{M4} to create corresponding data or multimedia segments ΔT_{M1}, ΔT_{M2}, ΔT_{M3} and ΔT_{M4} that may appear smoothly connected when joining the data segments ΔT_{M1} first, ΔT_{M3} second, ΔT_{M2} third and ΔT_{M4} forth. In some cases, the length of each original segment DT_{M1}, DT_{M2}, DT_{M3} or DT_{M4} may be chopped and/or artificially lengthened by processor 312 from the beginning and/or end of the segment, in order to create segments ΔT_{M1}, ΔT_{M2}, ΔT_{M3} and ΔT_{M4} that may appear to join smoothly. Therefore, the length of each segment ΔT_{M1}, ΔT_{M2}, ΔT_{M3} and ΔT_{M4} may be varied from the length of the corresponding segment DT_{M1}, DT_{M2}, DT_{M3} or DT_{M4}.

Additionally, for example, in some embodiments of the present invention a soundtrack may be composed to fit the video and, for example, the length of at least one video segment may be chopped off in order to fit the length of the video to the length of the soundtrack. In some embodiments, the video segments transition tempo in the created movie may be set by determining a certain length to each video segment. The transition tempo may be set, for example, according to a tempo of a certain soundtrack.

For example, processor 312 may analyze two data segments that are intended to be joined sequentially such as segments DT_{M3} and DT_{M2}, and find similar image data in both segments. For example, processor 312 may find similar image data at the beginning of DT_{M2} and at some image data between t₀₃ and the end of DT_{M3}. Processor 312 may chop segment DT_{M3} at the image data that was found similar to the image data at the beginning of DT_{M2} and thus, for example, create a data segment ΔT_{M3} that is shorter than DT_{M3}.

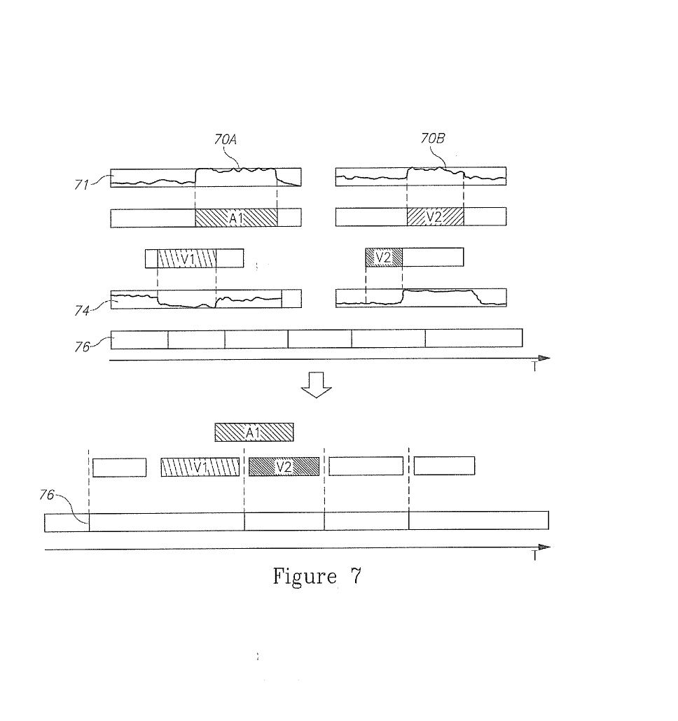

Reference is now made to FIG. 7, which is a schematic illustration of a method for creating a video according to embodiments of the present invention. In FIG. 7, video segments V1 and V2, audio segments A1 and A2, audio signal record 71, acceleration magnitude record 74, and soundtrack tempo 76 are shown along time T. As discussed above, according to some embodiments, computer processor 120 (or 312) may receive metadata 150 associated with the plurality of the multimedia files, metadata 150 may be provided as input to the decision function, and wherein the decision function may determine the start points and end points of the multimedia clips further based on the metadata 150. More specifically, computer processor 120 may receive a one or more audio files that may be used as a soundtrack for the generated sequence of multimedia clips, and wherein the decision function determines the start points and end points of the multimedia clips further based on a tempo derivable from the soundtrack or the length of the soundtrack. The soundtrack may be composed to fit the video and, for example, the length of at least one video segment may be chopped off in order to fit the length of the video to the length of the soundtrack. In some embodiments, the video segments transition tempo in the created movie may be set by determining a certain length to each video segment. The transition tempo may be set, for example, according to a tempo of a certain soundtrack 76. Specifically, the decision function may be applied so that the start point and end point of each one of the multimedia files are determined, at least partially, based on relations between key moments and kinematic data of the plurality of the multimedia files.

In embodiments of the present invention, a metadata file 150 may include a record of three-dimensional motion of device 310 such as, for example, a magnitude of acceleration record 74 of device 300 along time during the capturing process period, for example captured by acceleration sensor 322. As discussed above, the motion magnitude record 74 may be used for selecting by decision function 122 video segments such as, for example, video segments V1 and V2 shown in FIG. 7 with relatively small and/or monotonic movement, e.g. with small magnitude of acceleration.

Additionally, processor 120 (or 312) may receive audio files recorded, for example, by audio recorder 320. The audio file may include a audio signal record 71. Processor 120 (or 312) may identify volume peaks such as peaks 70A and 70B and may select corresponding audio segments A1 and A2 base of volume peaks 70A and 70B. Of the selected video segments, processor 120 may select by decision function 122, for example based on image data captured at the key moments, video segments V1 and V2 that may include distinct image data one from another, for example sufficiently different image data, that may cover, for example, variety of activities. Accordingly, video segments V1 and V2 may be from separate time portions.

Then, decision function 122 may decide which of the selected audio segments A1 or A2 should be included in the created video according to embodiments of the present invention. The audio segment may be chosen according to the strength of the volume peak, better fit with video segment or any other criteria. For example, audio segment A1 may be chosen. Audio segment A1 may fully or partially extend over both video segments V1 and V2, as shown in FIG. 7. As discussed above, the soundtrack tempo 76 may be used to adjust the video segments lengths so that the video segments transition tempo may match the soundtrack tempo and length as much as possible.

While certain features of the invention have been illustrated and described herein, many modifications, substitutions, changes, and equivalents will now occur to those of ordinary skill in the art. It is, therefore, to be understood that the appended claims are intended to cover all such modifications and changes as fall within the true spirit of the invention.

What is claimed is:

1. A method comprising:
receiving a plurality of multimedia files, wherein each one of the multimedia files is associated with kinematic data related to a capturing of each one of the multimedia files, and a key moment being a time stamp indicated by a human user;
obtaining a displaying order of the multimedia files;
applying a decision function, wherein the decision function receives as an input the plurality of multimedia files, the respective snap shot moments, the displaying order, and the kinematic data and determines as an output, for each one of the multimedia files, a start point and an end point,
wherein the start point and end point of each one of the multimedia files are determined, at least partially, on relations between snap shot moments and kinematic data of the plurality of the multimedia files.

2. The method according to claim 1, further comprising generating a displayable sequence of multimedia clips, each multimedia clip being a subset of its respective multimedia file, starting at its respective start point and ending at its respective end point by stitching together the multimedia clips based on the specified display order.

3. The method according to claim 2, wherein each one of the multimedia file comprises a video sequence and wherein the snap shot moment is associated with a single still image.

4. The method according to claim 1, wherein the determining of the start points and end points by the decision function is further based on data derived from the respective single still image.

5. The method according to claim 2, further comprising tagging each one of the multimedia clips with tags indicative of data derived from the still image.

6. The method according to claim 5, further comprising applying a predefined operation to the sequence of multimedia clips, based on the tags.

7. The method according to claim 5, further comprising applying a search operation for or on the sequence of the multimedia clips, based on the tags.

8. The method according to claim 1, wherein at least some of the multimedia files comprise both a video sequence and an audio sequence and wherein the decision function determines different start points and end points for at least some of the multimedia files.

9. The method according to claim 1, further comprising a receiving metadata associated with the plurality of the multimedia files, and wherein the decision function determines the start points and end points of the multimedia clips further based on the metadata.

10. The method according to claim 1, further comprising a receiving a soundtrack associated with the plurality of the multimedia files, and wherein the decision function determines the start points and end points of the multimedia clips further based on a tempo derivable from the soundtrack.

11. The method according to claim 2, wherein at least some additional multimedia files are provided after originally provided multimedia files, and wherein the additional multimedia files associated with specified display times along the specified order so that the decision function revises the start points and end points of both originally provided multimedia files and the additional multimedia files.

12. The method according to claim 2, wherein at least some additional multimedia files are provided after originally provided multimedia files, and wherein the additional multimedia files associated with specified display times along the specified order so that the decision function revises the start points and end points of both originally provided multimedia files and the additional multimedia files.

13. A system comprising:
a computer memory configured to receive and store a plurality of multimedia files, wherein each one of the multimedia files is associated with kinematic data related to a capturing of each one of the multimedia files, and a key moment being a time stamp indicated by a human user; and
a computer processor configured to obtain a displaying order of the multimedia files and to apply a decision function, wherein the decision function receives as an input the plurality of multimedia files, the respective snap shot moments, the displaying order, and the kinematic data and determines as an output, for each one of the multimedia files, a start point and an end point,
wherein the start point and end point of each one of the multimedia files are determined, at least partially, on relations between snap shot moments and kinematic data of the plurality of the multimedia files.

14. The system according to claim 13, wherein the computer processor is further configured to generate a displayable sequence of multimedia clips, each multimedia clip being a subset of its respective multimedia file, starting at its respective start point and ending at its respective end point by stitching together the multimedia clips based on the specified display order.

15. The system according to claim 13, wherein each one of the multimedia file comprises a video sequence and wherein the snap shot moment is associated with a single still image.

16. The system according to claim 13, wherein the determining of the start points and end points by the decision function is further based on data derived from the respective single still image.

17. The system according to claim 14, wherein the computer processor is further configured to tag each one of the multimedia clips with tags indicative of data derived from the still image.

18. The system according to claim 17, wherein the computer processor is further configured to apply a predefined operation to the sequence of multimedia clips, based on the tags.

19. The system according to claim 17, wherein the computer processor is further configured to apply a search operation for or on the sequence of the multimedia clips, based on the tags.

20. The system according to claim 13, wherein at least some of the multimedia files comprises both a video sequence and an audio sequence and wherein the decision function determines different start points and end points for at least some of the multimedia files.

21. The system according to claim 13, wherein the computer processor is further configured to receive metadata associated with the plurality of the multimedia files, and wherein the decision function determines the start points and end points of the multimedia clips further based on the metadata.

22. The system according to claim 13, wherein the computer processor is further configured to receive a soundtrack associated with the plurality of the multimedia files, and wherein the decision function determines the start points and end points of the multimedia clips further based on a tempo derivable from the soundtrack.
